(19) United States
(12) Patent Application Publication
(10) Pub. No.: US 2015/0195084 A1
(43) Pub. Date: Jul. 9, 2015

(54) ONE-BIT TO FOUR-BIT DUAL CONVERSION APPARATUS FOR ENHANCED SECURITY AGAINST SIDE CHANNEL ANALYSIS AND METHOD THEREOF

(71) Applicant: Electronics and Telecommunications Research Institute, Daejeon (KR)

(72) Inventors: Seung Kwang LEE, Daejeon (KR); Doo Ho CHOI, Cheonan-si (KR)

(73) Assignee: Electronics and Telecommunications Research Institute, Daejeon (KR)

(21) Appl. No.: 14/317,568

(22) Filed: Jun. 27, 2014

(30) Foreign Application Priority Data
Jan. 9, 2014 (KR) 10-2014-0002818

(51) Int. Cl. H04L 9/06

(52) U.S. Cl. CPC H04L 9/0618

(57) ABSTRACT

Disclosed is a dual conversion apparatus for preventing a side channel analysis, including: a microcontroller which converts one-bit expression, which is expressed by zero and one, into one of two four-bit transitions, reconstructs a cryptographic algorithm, and applies the four-bit converted dual conversion to the reconstructed cryptographic algorithm; and a storing unit which stores the four-bit converted dual conversion which is converted by the microcontroller.

### CROSS-REFERENCE TO RELATED APPLICATIONS

This application claims priority to and the benefit of Korean Patent Application No. 10-2014-0002818 filed in the Korean Intellectual Property Office on Jan. 9, 2014, the entire contents of which are incorporated herein by reference.

### TECHNICAL FIELD

The present invention relates to a one-bit to four-bit dual conversion apparatus for enhanced security against a side channel analysis and a method thereof, and more particularly, to a one-bit to four-bit dual conversion apparatus for enhanced security against a side channel analysis and a method thereof which restrict extracting confidential information in a cryptographic operating device using leakage information such as power consumption or an electromagnetic wave generated during a cryptographic operation by the cryptographic operating device.

### BACKGROUND ART

Attack on a cryptographic operating device by a side channel analysis is an analyzing method which analyzes information on power consumption or an electromagnetic wave generated in security electronic equipment, which performs a cryptographic algorithm, to obtain confidential information such as an encryption key.

In order to cope with this, a software dual rail technology is configured to generate a one-bit flip in an operation, which is dependent on the key, to flow a constant current.

One the serious problem in accepting their solutions, however, has been the fact that software DPL is on the assumption that manipulating (0,1) and (1,0) lead to the same power consumption. However, this is not always true in practice. Rather, the power consumption is dependent on both the Hamming weight and bit positions set. For example, if the wire for bit one is closer to the bus than that of the other bits, then changing bit one may have influence on the change in measured current more than changing the others.

### SUMMARY

The present invention has been made in an effort to provide a dual conversion apparatus for preventing a side channel analysis and a method thereof which induce zero to one conversion and one to zero conversion at the same ratio in a CMOS circuit through one-bit to four-bit dual conversion, regardless of the operation and data.

The present invention has also been made in an effort to provide a one-bit to four-bit dual conversion apparatus for enhanced security against a side channel analysis and a method thereof which provide an AES algorithm to which a dual conversion technique is applied.

An exemplary embodiment of the present invention provides a one-bit to four-bit dual conversion apparatus for enhanced security against a side channel analysis including: a microcontroller which converts one-bit expression, which is expressed by zero and one, into one of two four-bit transitions, reconstructs a cryptographic algorithm, and applies the four-bit converted dual conversion to the reconstructed cryptographic algorithm; and a storing unit which stores the four-bit converted dual conversion which is converted by the microcontroller.

According to an aspect of the present invention, in the dual conversion, when the dual conversion is performed with uniform distribution, a probability that zero is located in each bit and a probability that one is located in each bit may be the same as each other, and a hamming weight of all intermediate operational values of four-bit unit may be 2.

According to an aspect of the present invention, the microcontroller may convert 0, between one-bit expression which is expressed by zero and one, into one of 0101 and 1010 and convert 1 into one of 0110 and 1001.

According to an aspect of the present invention, the microcontroller may apply a bit dual conversion algorithm to a lookup table, which is generated by a composite function of constitutional functions of a block cryptographic algorithm, to reconstruct the block cryptographic algorithm, when the cryptographic algorithm is a block cryptographic algorithm including AES or ARIA.

According to an aspect of the present invention, the microcontroller may apply the four-bit converted dual conversion to all the reconstructed cryptographic algorithms in which an intermediate value is used.

Another exemplary embodiment of the present invention provides a one-bit to four-bit dual conversion method for enhanced security against a side channel analysis, including: converting, by a microcontroller, one-bit expression, which is expressed by zero and one, into one of two four-bit transitions; reconstructing, by the microcontroller, a cryptographic algorithm; and applying, by the microcontroller, the four-bit converted dual conversion to the reconstructed cryptographic algorithm.

According to an aspect of the present invention, the converting of one-bit expression, which is expressed by zero and one, into one of two four-bit transitions may include converting, by the microcontroller, 0, between one-bit expression which is expressed by zero and one, into one of 0101 and 1010 and converting 1 into one of 0110and 1001.

According to an aspect of the present invention, the applying of the four-bit converted dual conversion to the reconstructed cryptographic algorithm may include applying, by the microcontroller, a bit dual conversion algorithm to a lookup table, which is generated by a composite function of constitutional functions of a block cryptographic algorithm, to reconstruct the block cryptographic algorithm, when the cryptographic algorithm is a block cryptographic algorithm including AES or ARIA.

According to an aspect of the present invention, the applying of the four-bit converted dual conversion to the reconstructed cryptographic algorithm may include applying the four-bit converted dual conversion to all the reconstructed cryptographic algorithms in which an intermediate value is used.

The one-bit to four-bit dual conversion apparatus for enhanced security against a side channel analysis and the method thereof according to the exemplary embodiment of the present invention may cope with a mono-bit DPA (differential power analysis) attack, a multi-bit DPA attack, and a CPA (correlation power analysis) attack, by inducing the zero to one conversion and the one to zero conversion at the same rate in the CMOS circuit through the one-bit to four-bit dual conversion, regardless of the operation and data.

The one-bit to four-bit dual conversion apparatus for enhanced security against a side channel analysis and the method thereof according to the exemplary embodiment of the present invention may cope with various side channel analyses by resetting a cryptographic algorithm such that the dual conversion technique is applied to all intermediate values.

### BRIEF DESCRIPTION OF THE DRAWINGS

FIG. 1 is a diagram of a one-bit to four-bit dual conversion apparatus for enhanced security against a side channel analysis according to an exemplary embodiment of the present invention.

FIG. 2 is a view illustrating a one-bit to four-bit dual conversion table according to an exemplary embodiment of the present invention.

FIG. 3 is a view illustrating an 8-bit to 32-bit dual conversion algorithm according to an exemplary embodiment of the present invention.

FIG. 4 is a view illustrating a 32-bit to 8-bit inverse dual conversion algorithm according to an exemplary embodiment of the present invention.

FIG. 5 is a view illustrating a 32-bit to 32-bit or 128 bit mapping using a binary selection tree in which stability is not considered, according to an exemplary embodiment of the present invention.

FIG. 6 is a view illustrating an arbitrary rotation for each node according to an exemplary embodiment of the present invention.

FIG. 7 is a view illustrating a binary selection tree to which the arbitrary rotation for each node is applied, according to an exemplary embodiment of the present invention.

FIG. 8 is a view illustrating an XOR operation according to an exemplary embodiment of the present invention.

FIG. 9 is a flowchart illustrating a one-bit to four-bit dual conversion method for enhanced security against a side channel analysis according to an exemplary embodiment of the present invention.

### DETAILED DESCRIPTION

It should be noted that technical terminologies used in the present invention are used to describe a specific exemplary embodiment but are not intended to limit the present invention. The technical terminologies which are used in the present invention should be interpreted to have meanings that are generally understood by those with ordinary skill in the art to which the present invention pertains, unless specifically defined to have different meanings in the present invention, but not be interpreted as an excessively comprehensive meaning or an excessively restricted meaning. If a technical terminology used in the present invention is an incorrect technical terminology which does not precisely describe the spirit of the present invention, the technical terminology should be replaced with and understood as a technical terminology which may be correctly understood by those skilled in the art. A general terminology used in the present invention should be interpreted as defined in a dictionary or in accordance with the context, but not be interpreted as an excessively restricted meaning.

A singular form used in the present invention may include a plural form unless it has a clearly opposite meaning in the context. Terminologies such as “be configured by” or “include” in the present invention should not be interpreted to necessarily include all of plural components or plural steps described in the present invention, but should be interpreted not to include some of the components or steps or to further include additional components or steps.

Terminologies including an ordinal number such as first or second which is used in the present invention may be used to explain components, but the components are not limited by the terminologies. The above terminologies are used only for distinguishing one component from another component. For example, without departing from the scope of the present invention, the first component may be referred to as the second component, and similarly, the second component may also be referred to as the first component.

Hereinafter, exemplary embodiments according to the present invention will be described in detail with reference to the accompanying drawings, and the same or similar components are denoted by the same reference numerals regardless of reference numerals, and repeated description thereof will be omitted.

In describing the present invention, when it is determined that a detailed description of a related publicly known technology may obscure the gist of the present invention, the detailed description thereof will be omitted. Further, it is noted that the accompanying drawings are used just for easily appreciating the spirit of the present invention and it should not be interpreted that the spirit of the present invention is limited by the accompanying drawings.

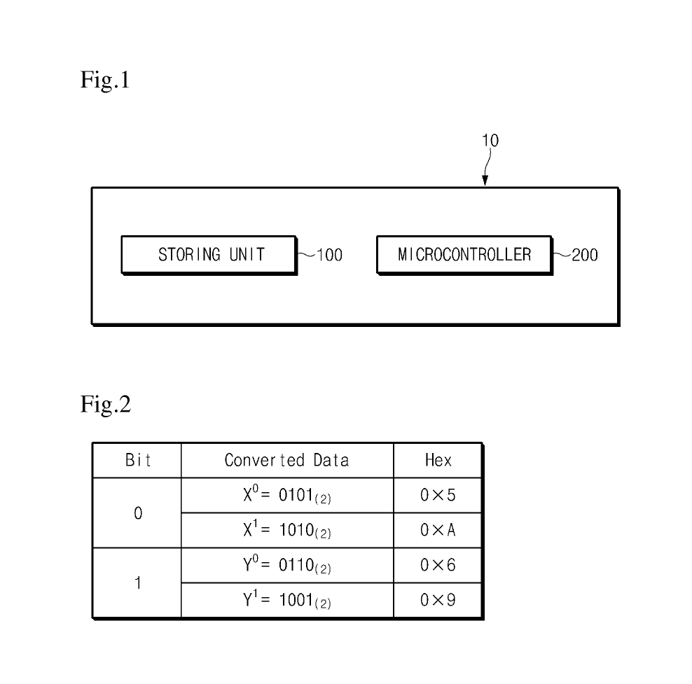

FIG. 1 is a diagram of a one-bit to four-bit dual conversion apparatus 10 for enhanced security against a side channel analysis according to an exemplary embodiment of the present invention.

As illustrated in FIG. 1, the dual conversion apparatus 10 includes a storing unit 100 and a microcontroller 200. However, all the components of the dual conversion apparatus 10 illustrated in FIG. 1 are not essential components, but the dual conversion apparatus 10 may be implemented by more components or less components than the components illustrated in FIG. 1.

A probability that zero is located in each bit and a probability that one is located in each bit are the same as each other, and a four-bit dual conversion, which has a characteristic that a hamming weight of all intermediate operational values of four-bit unit is 2, is defined, and a dual conversion property is applied to a cryptographic algorithm to cope with (or prevent) the side channel analysis.

The storing unit (or memory) 100 stores data and a program required to operate the dual conversion apparatus 10.

The storing unit 100 stores various user interfaces UI and graphic user interfaces GUI.

The storing unit 100 may include at least one storing medium of a flash memory type, a hard disk type, a multimedia card micro type, a card type memory (for example, an SD or XD memory), a magnetic memory, a magnetic disk, an optical disk, a random access memory (RAM), a static random access memory, a read-only memory (ROM), an electrically erasable programmable read-only memory (EEPROM), and a programmable read-only memory (PROM). Further, the dual conversion apparatus 10 may operate a web storage which performs a storing function of the storing unit 100 on the Internet or operate in association with the web storage.

The microcontroller (or controller) 200 controls an overall operation of the dual conversion apparatus 10.

The microcontroller 200 converts one-bit expression, which is expressed by zero and one, into one of two four-bit transitions. In this case, when the dual conversion is performed with uniform distribution, the microcontroller 200 performs (or sets) the dual conversion so as to satisfy a first property that the probability that zero is located in each bit and the probability that one is located in each bit are the same as each other and a second property that the hamming weight of all the intermediate operational values in four-bit unit is 2. Further, the microcontroller 200 stores the converted dual conversion in the storing unit 100.

That is, the microcontroller 200 defines a dual conversion table which satisfies the first property and the second property such as a dual conversion table illustrated in FIG. 2. In this case, the microcontroller 200 converts 0 into one of 0101 and 1010. Further, the microcontroller 200 converts 1 into one of 0110 and 1001.

The microcontroller 200 may expand a one-bit to four-bit dual conversion to an 8-bit to 32-bit transition.

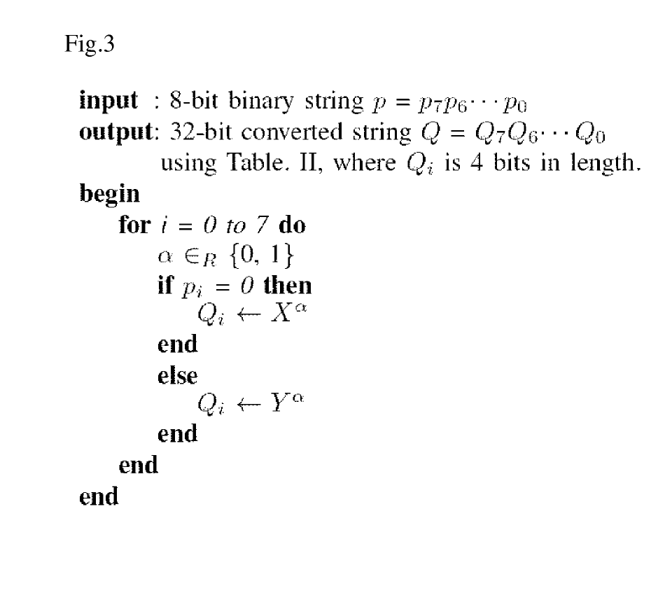

That is, as illustrated in FIG. 3, the microcontroller 200 defines an 8-bit to 32-bit dual conversion algorithm (or δ (delta)).

In the 8-bit to 32-bit dual conversion algorithm (or dual conversion) illustrated in FIG. 3, the microcontroller 200 may perform transformation such as changing of an order of the conversion, changing of an order of X and Y, or changing of the number of bits in accordance with the request of a designer (or a user). In this case, a is a value obtained by randomly selecting one of zero and one and only when a is uniformly distributed, the first property which is required for the dual conversion described above may be satisfied. That is, after the dual conversion, the probability that zero is located in each bit is the same as the probability that one is located in each bit.

The microcontroller 200 may repeatedly use the dual conversion algorithm illustrated in FIG. 3 to convert a 16 byte intermediate value into a 64 byte value.

The microcontroller 200 may inversely convert a value, which is converted into 32-bit, into 8-bit, which is an original value, in order to output an cryptograph after the last round operation.

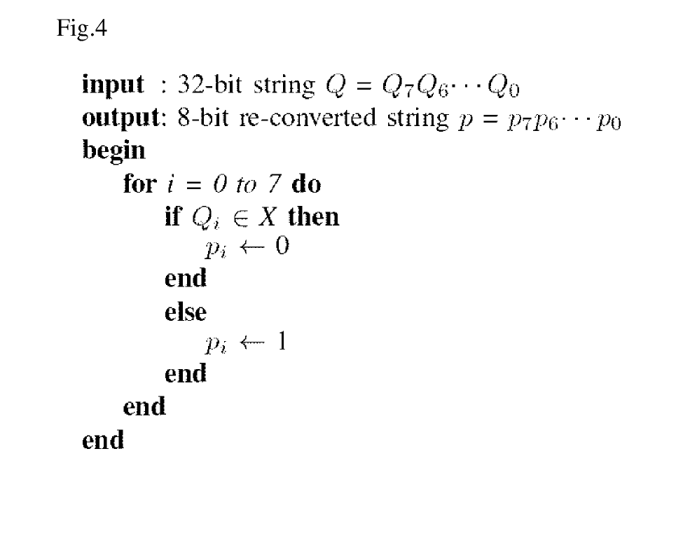

That is, as illustrated in FIG. 4, the microcontroller 200 defines a 32-bit to 8-bit inverse conversion algorithm (or δ⁻¹).

As described above, the microcontroller 200 performs one-bit to four-bit dual conversion so as to satisfy the first property and the second property and stores a dual converted value in the storing unit 100.

The microcontroller 200 reconstructs the cryptographic algorithm in order to apply the dual converted value to the cryptographic algorithm. Here, the cryptographic algorithm is described based on a block cryptographic algorithm such as AES or Academy Research Institute Agency (ARIA), but is not limited thereto.

As an example for applying the dual conversion to the block cryptographic algorithm, if it is assumed that functions which configure the cryptographic algorithm are f1, f2, fn and a composite function of the functions is g(x)=fn • . . . • f2•f1(x), the microcontroller 200 may reconstruct the cryptographic algorithm as a set of one or a plurality of lookup tables based on g(x).

That is, if it is assumed that the dual conversion is δ and repeated usage of δ is Δ, the microcontroller 200 may apply the dual conversion to all result values of the lookup table through Δ•g(x).

After applying the dual conversion, a size of data, which is input to the lookup table of the cryptographic algorithm, is increased by four times.

For example, when a size of an input for S-box is 8 bit, the size of the input after applying the dual conversion is 32-bit. Therefore, a method which maps an input in which the dual conversion is applied to the lookup table in a given form of Δ•g(x) with a result value to which the dual conversion is applied is required.

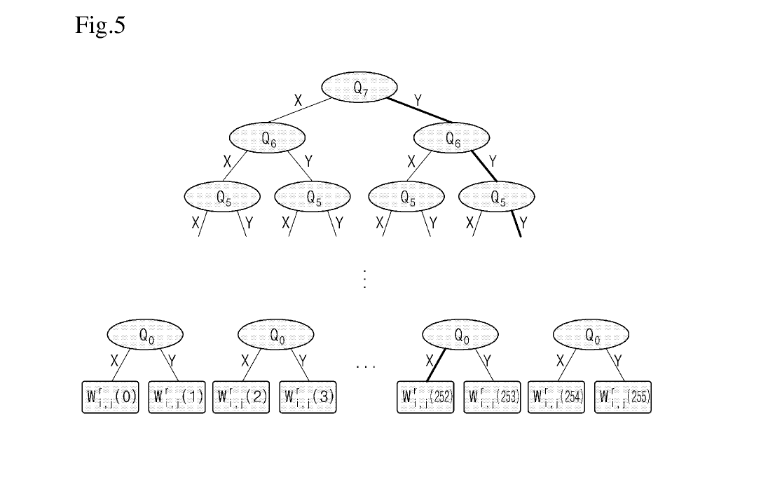

That is, if a result of applying the dual conversion to an 8-bit input x is Q=δ(x), the microcontroller 200 uses a binary selection tree, which is illustrated in FIGS. 5 to 7, in order to map the table lookup result value Δ•g(x) for the input Q.

If a space in which a storage space which is used to store the input and the intermediate value is rearranged to be a two-dimensional arrangement, like the block cryptographic algorithm such as the AES, is S_{i,j}, the round is r, and an intermediate value after applying the dual conversion to each cryptographic function is W^{r}_{i,j}, an input for the cryptographic function of the general block cryptographic algorithm is 8 bit, and an intermediate value which is given as a result of the table lookup may have sizes of 32, 64, or 128 bit depending on a method of composing the cryptographic function. Therefore, the number of leaf nodes of the binary selection tree for performing Q->Δ•g(x) is 255 and a value of W^{r}_{i,j} may be 32, 64, or 128. Here, the configuration of the binary selection tree is not limited to the above examples, but may be set in accordance the design of a designer.

FIG. 5 illustrates mapping from 32-bit to 32, 64, or 128 bit using a binary selection tree in which stability is not considered. As illustrated in FIG. 5, if the four-bit is classified as X when each four-bit is X⁰ or X¹ and the four-bit is classified as Y when each four-bit is Y⁰ or Y¹ to repeatedly select left and right branches, a value of W may be traced by tracing a path from a roof node to a leaf node.

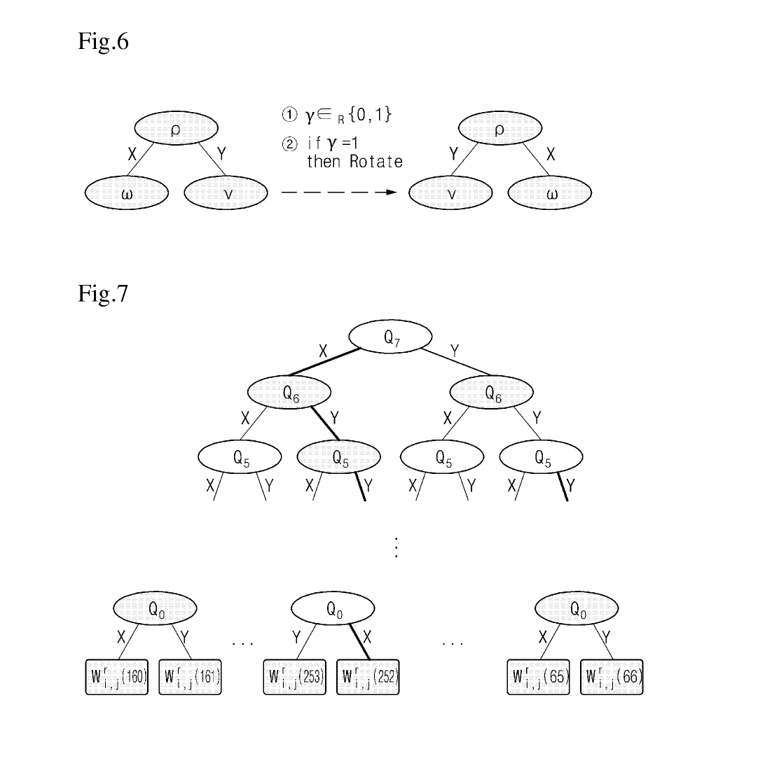

However, the simple type mapping illustrated in FIG. 5 may leak an original intermediate value which is inversely converted during a process of selecting a branch of the tree. Therefore, in the present invention, as illustrated in FIGS. 6 and 7, a binary selection tree which is arbitrarily rotated in each node is used and the leaf node is also rearranged through information rotated in each node. In this case, in order to prevent a number of cases of path tracing which is not rotated at all from being generated, the roof node is necessarily rotated based on FIG. 6.

The microcontroller 200 may perform an XOR operation in order to combine an intermediate value which is generated in a cryptographic operation. In this case, since the XOR operation through a bitwise operation by the definition may not be performed on the intermediate value after dual conversion, the XOR operation is performed by a newly defined XOR operation method.

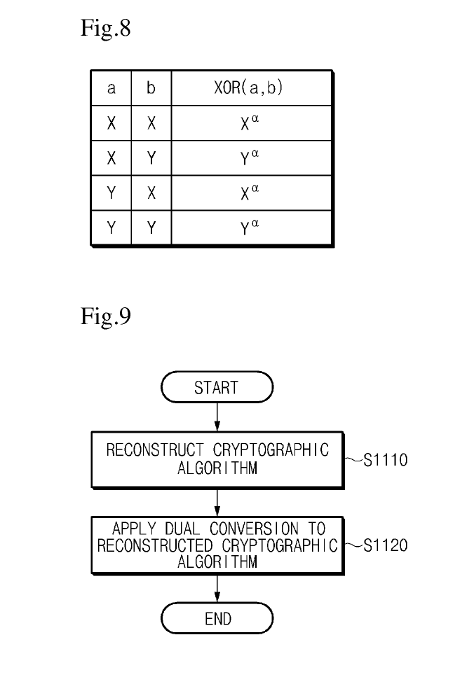

That is, as illustrated in FIG. 8, the microcontroller 200 defines a truth table which indicates an output value for two four-bit inputs. In this case, a is generated as a value with uniform distribution so as to be configured to satisfy a first property of the dual conversion. The XOR operation based on the truth table may be performed through a lookup table or may be directly assigned in a storage based on an arbitrarily generated α.

As described above, zero to one conversion and one to zero conversion at the same rate may be induced in the CMOS circuit through one-bit to four-bit dual conversion, regardless of the operation and the data.

As described above, the cryptographic algorithm may be reset such that the dual conversion technique is applied to all intermediate values.

Hereinafter, a dual conversion method for preventing a side channel analysis according to an exemplary embodiment of the present invention will be described in detail with reference to FIGS. 1 to 9.

FIG. 9 is a flowchart illustrating a dual conversion method for preventing a side channel analysis according to an exemplary embodiment of the present invention.

First, the microcontroller 200 reconstructs a cryptographic algorithm.

For example, the microcontroller 200 reconstructs the cryptographic algorithm in order to apply the dual converted value to the cryptographic algorithm in step S910.

Next, the microcontroller 200 applies the dual conversion, which is stored in the storing unit 100 in advance, to the reconstructed cryptographic algorithm. Here, the dual conversion converts one-bit expression, which is expressed by zero and one, into one of two four-bit transitions and has two properties. That is, when the dual conversion is performed with uniform distribution, one property is that a probability that zero is located in each bit and a probability that one is located in each bit are the same as each other and the other property is that a hamming weight of all intermediate operation values of four-bit unit is 2.

That is, the microcontroller 200 applies the dual conversion, which is stored in advance, to all cryptographic algorithms in which an intermediate value is used, among the reconstructed cryptographic algorithms.

For example, the microcontroller 200 applies the dual conversion, which is stored in the storing unit 100 in advance, to the reconstructed cryptographic algorithm in step S920.

As described above, the exemplary embodiment of the present invention may cope with various side channel analyses by resetting the cryptographic algorithm such that the dual conversion technique is applied to all intermediate values.

That is, in order to perform the mono-bit DPA attack, an attacker needs to divide a waveform into two sets based on a specific bit of intermediate value and calculate a differential power between averages of the sets. However, if the dual conversion of the present invention is applied to each bit, a probability that zero is located in the position of each bit is the same as a probability that one is located in the position of each bit, regardless of whether to be zero or one, thereby copying with (or preventing) the mono-bit DPA attack. Here, the conversions need to be uniformly distributed.

The multi-bit DPA attack is generalization of the mono-bit DPA attack. When an attacker divides a waveform based on specific bits of a specific intermediate value, the waveforms which are uniformly dual-converted have the same probability that the operated is performed in the status where zero and one are located in the position so that half the set acts as noise. A peak disappears from a differential power waveform in a state where half the set is noise so that the attack is meaningless.

It is possible to cope with the DCA attack with the same principle as the DPA attack.

The CPA attack has a premise that power consumption in the microcontroller 200 is in proportion to the Hamming weight and bit positions set of values being manipulated. In the present invention, the attacker cannot apply a power leakage model for power simulation because dual converted intermediate values have the Hamming weight 2 and bit positions of binary ‘1’s in X0, X1, Y0, and Y1 are too mixed up for the attacker to distinguish. Therefore, it is possible to incapacitate (prevent) the CPA attacker from calculating a correlation coefficient through the power simulation to analogize a confidential key.

Various changes or modifications of the above description may be made by those skilled in the art without departing from the spirit and scope of the present invention. For example, the scope of the present invention may comprise one bit to n-bit dual conversion for n(ex. n is an integer). Accordingly, the various exemplary embodiments disclosed herein are not intended to limit the technical spirit of the present invention and the scope of the technical spirit of the present invention is not restricted by the exemplary embodiments. The protection scope of the present invention should be interpreted based on the following appended claims and it should be appreciated that all technical spirits included within a range equivalent thereto are included in the protection scope of the present invention.

What is claimed is:

1. A dual conversion apparatus for preventing a side channel analysis, the apparatus comprising:
a microcontroller which converts one-bit expression, which is expressed by zero and one, into one of two four-bit transitions, reconstructs a cryptographic algorithm, and applies the four-bit converted dual conversion to the reconstructed cryptographic algorithm; and
a storing unit which stores the four-bit converted dual conversion which is converted by the microcontroller.

2. The apparatus of claim 1, wherein in the dual conversion, when the dual conversion is performed with uniform distribution, a probability that zero is located in each bit and a probability that one is located in each bit are the same as each other, and a hamming weight of all intermediate operational values of four-bit unit is 2.

3. The apparatus of claim 1, wherein the microcontroller converts 0, between one-bit expression which is expressed by zero and one, into one of 0101 and 1010 and converts 1 into one of 0110 and 1001.

4. The apparatus of claim 1, wherein the microcontroller applies a bit dual conversion algorithm to a lookup table, which is generated by a composite function of constitutional functions of a block cryptographic algorithm, to reconstruct the block cryptographic algorithm when the cryptographic algorithm is a block cryptographic algorithm including AES or ARIA.

5. The apparatus of claim 4, wherein the microcontroller applies the four-bit converted dual conversion to all the reconstructed cryptographic algorithm in which an intermediate value is used.

6. A dual conversion method for preventing a side channel analysis, the method comprising:
converting, by a microcontroller, one-bit expression, which is expressed by zero and one, into one of two four-bit transitions;
reconstructing, by the microcontroller, a cryptographic algorithm; and
applying, by the microcontroller, the four-bit converted dual conversion to the reconstructed cryptographic algorithm.

7. The method of claim 6, wherein in the dual conversion, when the dual conversion is performed with uniform distribution, a probability that zero is located in each bit and a probability that one is located in each bit are the same as each other, and a hamming weight of all intermediate operational values of four-bit unit is 2.

8. The method of claim 6, wherein the converting of one-bit expression, which is expressed by zero and one, into one of two four-bit transitions includes converting, by the microcontroller, 0, between one-bit expression which is expressed by zero and one, into one of 0101 and 1010 and converting 1 into one of 0110 and 1001.

9. The method of claim 6, wherein the applying of the four-bit converted dual conversion to the reconstructed cryptographic algorithm includes applying, by the microcontroller, a bit dual conversion algorithm to a lookup table, which is generated by a composite function of constitutional functions of a block cryptographic algorithm, to reconstruct the block cryptographic algorithm through the microcontroller when the cryptographic algorithm is a block cryptographic algorithm including AES or ARIA.

10. The method of claim 9, wherein the applying of the four-bit converted dual conversion to the reconstructed cryptographic algorithm includes applying the four-bit converted dual conversion to all the reconstructed cryptographic algorithms in which an intermediate value is used.
